(19) United States
(12) Patent Application Publication
(10) Pub. No.: US 2019/0303774 A1
(43) Pub. Date: Oct. 3, 2019

(54) Dataset completion

(71) Applicant: Celect, Inc., Boston, MA (US)

(72) Inventors: Devavrat Shah, Waban, MA (US); Sai Kiran Burle, Mountain View, CA (US); Ritesh Madan, Berkeley, CA (US)

(21) Appl. No.: 16/370,232

(22) Filed: Mar. 29, 2019

Related U.S. Application Data
(60) Provisional application No. 62/649,740, filed on Mar. 29, 2018.

(51) Int. Cl. G06N 5/04; G06N 3/08

(52) U.S. Cl. CPC G06N 5/04; G06N 3/08

(57) ABSTRACT

Systems and methods for completing at least one entry in a dataset. The systems and methods described herein find a rich set of dense features for each of a plurality of entities, then combine the rich set of dense features with externally provided features to estimate a target value. The systems and methods combine these features using a neural network model in which portions of the input layer are each only connected to a portion of the hidden layer.

### CROSS-REFERENCE TO RELATED APPLICATIONS

The present application claims the benefit of co-pending U.S. provisional application No. 62/649,740, filed on Mar. 29, 2018, the entire disclosure of which is incorporated by reference as if set forth in its entirety herein.

### TECHNICAL FIELD

Embodiments described herein generally relate to systems and methods for predicting missing entries in a dataset.

### BACKGROUND

Neural networks have been used extensively to solve various types of data science problems. However, neural networks generally need to be custom designed and specifically trained with data to solve a particular type of problem.

### SUMMARY

This summary is provided to introduce a selection of concepts in a simplified form that are further described below in the Detailed Description section. This summary is not intended to identify or exclude key features or essential features of the claimed subject matter, nor is it intended to be used as an aid in determining the scope of the claimed subject matter.

In one aspect, embodiments relate to a system for completing at least one entry in a dataset. The system includes an interface for receiving a dataset, wherein the dataset includes at least one unknown value, and a processor executing instructions stored on a memory to provide a model to obtain internally inferred features relating to each of a plurality of entities, combine the internally inferred features relating to each of the plurality of entities with at least one externally provided feature related to each entity, and estimate the at least one unknown value based on the combination of the internally provided features relating to each entity and the at least one externally provided feature related to each entity.

In some embodiments, the model is a neural network. In some embodiments, the internally inferred features are arranged as a plurality of one-hot encoded vectors that each relate to an entity. In some embodiments, the plurality of one-hot encoded vectors represent an input layer of the neural network, and the at least one externally provided feature is represented as a portion of a hidden layer of the neural network. In some embodiments, a first one-hot encoded vector relating to a first entity is combined with the portion of the hidden layer that represents the at least one externally provided feature that relates to the first entity.

In some embodiments, the processor is further configured to output a target vector estimating the at least one unknown value.

According to another aspect, embodiments relate to a method for completing at least one entry in a dataset. The method includes receiving at an interface a dataset including at least one unknown value; obtaining, using a processor executing instructions stored on a memory to provide a model, internally inferred features relating to each of a plurality of entities; combining the internally inferred features relating to each of the plurality of entities with at least one externally provided feature related to each entity; and estimating the at least one unknown value based on the combination of the internally provided features relating to each entity and the at least one externally provided feature related to each entity.

In some embodiments, the model is a neural network. In some embodiments, the internally inferred features are arranged as a plurality of one-hot encoded vectors that each relate to an entity. In some embodiments, the plurality of one-hot encoded vectors represent an input layer of the neural network, and the at least one externally provided feature is represented as a portion of a hidden layer of the neural network. In some embodiments, combining the internally inferred features relating to each of the plurality of entities with the at least one externally provided feature includes combining a first one-hot encoded vector relating to a first entity with the portion of the hidden layer that represents the at least one externally provided feature that relates to the first entity.

In some embodiments, the processor is further configured to output a target vector estimating the at least one unknown value.

Other objects and features will become apparent from the following detailed description considered in conjunction with the accompanying drawings. It is to be understood, however, that the drawings are intended as an illustration only and not as a definition of the limits of the present disclosure.

### BRIEF DESCRIPTION OF DRAWINGS

Non-limiting and non-exhaustive embodiments of the invention are described with reference to the following figures, wherein like reference numerals refer to like parts throughout the various views unless otherwise specified.

FIG. 1 illustrates a system for completing at least one entry in a dataset in accordance with one embodiment;

FIG. 2 illustrates an input vector comprising a plurality of one-hot encoded vectors in accordance with one embodiment;

FIG. 3 illustrates a portion of a neural network framework in accordance with one embodiment;

FIG. 4 illustrates a conventional neural network framework;

FIG. 5 illustrates a neural network framework in accordance with one embodiment; and

FIG. 6 depicts a flowchart of a method for completing at least one entry in a dataset in accordance with one embodiment.

### DETAILED DESCRIPTION

Various embodiments are described more fully below with reference to the accompanying drawings, which form a part hereof, and which show specific exemplary embodiments. However, the concepts of the present disclosure may be implemented in many different forms and should not be construed as limited to the embodiments set forth herein; rather, these embodiments are provided as part of a thorough and complete disclosure, to fully convey the scope of the concepts, techniques and implementations of the present disclosure to those skilled in the art. Embodiments may be practiced as methods, systems or devices. Accordingly, embodiments may take the form of a hardware implementation, an entirely software implementation or an implementation combining software and hardware aspects. The following detailed description is, therefore, not to be taken in a limiting sense.

Reference in the specification to “one embodiment” or to “an embodiment” means that a particular feature, structure, or characteristic described in connection with the embodiments is included in at least one example implementation or technique in accordance with the present disclosure. The appearances of the phrase “in one embodiment” in various places in the specification are not necessarily all referring to the same embodiment.

Some portions of the description that follow are presented in terms of symbolic representations of operations on non-transient signals stored within a computer memory. These descriptions and representations are used by those skilled in the data processing arts to most effectively convey the substance of their work to others skilled in the art. Such operations typically require physical manipulations of physical quantities. Usually, though not necessarily, these quantities take the form of electrical, magnetic or optical signals capable of being stored, transferred, combined, compared and otherwise manipulated. It is convenient at times, principally for reasons of common usage, to refer to these signals as bits, values, elements, symbols, characters, terms, numbers, or the like. Furthermore, it is also convenient at times, to refer to certain arrangements of steps requiring physical manipulations of physical quantities as modules or code devices, without loss of generality.

However, all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system memories or registers or other such information storage, transmission or display devices. Portions of the present disclosure include processes and instructions that may be embodied in software, firmware or hardware, and when embodied in software, may be downloaded to reside on and be operated from different platforms used by a variety of operating systems.

The present disclosure also relates to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each may be coupled to a computer system bus. Furthermore, the computers referred to in the specification may include a single processor or may be architectures employing multiple processor designs for increased computing capability.

The processes and displays presented herein are not inherently related to any particular computer or other apparatus. Various general-purpose systems may also be used with programs in accordance with the teachings herein, or it may prove convenient to construct more specialized apparatus to perform one or more method steps. The structure for a variety of these systems is discussed in the description below. In addition, any particular programming language that is sufficient for achieving the techniques and implementations of the present disclosure may be used. A variety of programming languages may be used to implement the present disclosure as discussed herein.

In addition, the language used in the specification has been principally selected for readability and instructional purposes and may not have been selected to delineate or circumscribe the disclosed subject matter. Accordingly, the present disclosure is intended to be illustrative, and not limiting, of the scope of the concepts discussed herein.

As discussed previously, one may wish to predict missing values in a dataset that relate to entities or interactions between entities. For example, retail companies may have a large amount of data regarding shoppers such as their gender, age, shopping habits, browsing history (both online and in physical stores), purchase history, ratings assigned to items purchased, etc. As another example, companies such as clothing companies may have data regarding certain items for sale such as their color, size, and material, as well as the number times the item was sold. Often times these companies may have incomplete data or may otherwise want to predict events such as the number of times a particular item will be purchased, or whether a user is likely to rate a movie favorably.

Machine learning models and techniques such as neural networks can be used to solve these types of problems. However, existing neural networks generally need to be custom designed and trained to analyze specific data.

Most machine learning-based or data science problems outlined above can be mapped to a general tensor completion framework described in Applicant's co-pending U.S. patent application Ser. No. 15/294,659, filed on Oct. 14, 2016, and Applicant's co-pending U.S. patent application Ser. No. 15/844,613 filed on Dec. 17, 2017, the contents of which are incorporated by reference as if set forth in their entirety herein.

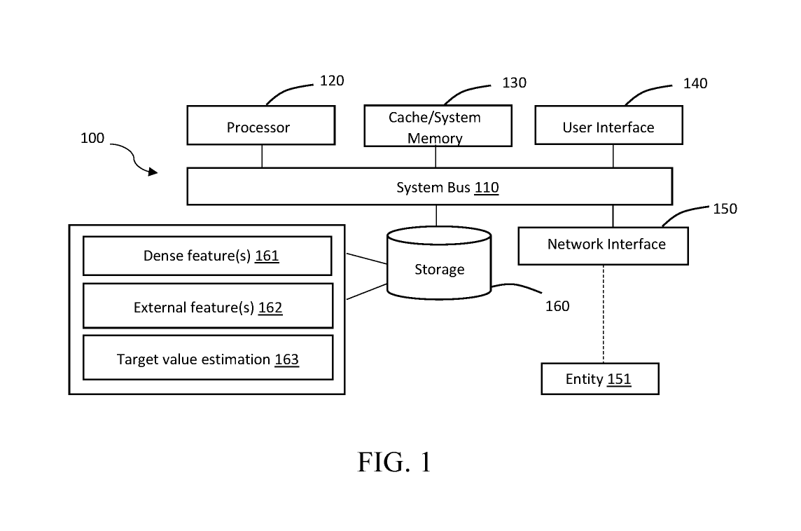

FIG. 1 illustrates a system 100 for completing at least one entry in a dataset in accordance with one embodiment. The system 100 may include a processor 120, memory 130, a user interface 140, a network interface 150, and storage 160, all interconnected via one or more system buses 110. It will be understood that FIG. 1 constitutes, in some respects, an abstraction and that the actual organization of the system 100 and the components thereof may differ from what is illustrated.

The processor 120 may be any hardware device capable of executing instructions stored on memory 130 or in storage 160, or otherwise any hardware device capable of processing data. As such, the processor 120 may include a microprocessor, field programmable gate array (FPGA), application-specific integrated circuit (ASIC), or other similar devices.

The memory 130 may include various transient memories such as, for example L1, L2, or L3 cache or system memory. As such, the memory 130 may include static random access memory (SRAM), dynamic RAM (DRAM), flash memory, read only memory (ROM), or other similar memory devices and configurations.

The user interface 140 may include one or more devices for enabling communication with system operators and other personnel. For example, the user interface 140 may include a display, a mouse, and a keyboard for receiving user commands. In some embodiments, the user interface 140 may include a command line interface or graphical user interface that may be presented to a remote terminal via the network interface 150. The user interface 140 may execute on a user device such as a PC, laptop, tablet, mobile device, or the like, and may enable a user to input parameters regarding various entities and receive data regarding said entities.

The network interface 150 may include one or more devices for enabling communication with other remote devices and entities to access one or more data sources comprising operational data regarding entities of interest. For example, the network interface 150 may include a network interface card (NIC) configured to communicate according to the Ethernet protocol. Additionally, the network interface 150 may implement a TCP/IP stack for communication according to the TCP/IP protocols. Various alternative or additional hardware or configurations for the network interface 150 will be apparent.

The network interface 150 may receive data from one or more entities 151 for analysis. The entity may be, for example, a retailer providing data regarding shoppers, items for sale, sales data, or the like.

The entity 151 may be in communication with the system 100 over one or more networks that link the various components of system 100 with various types of network connections. The network(s) may be comprised of, or may interface to, any one or more of the Internet, an intranet, a Personal Area Network (PAN), a Local Area Network (LAN), a Wide Area Network (WAN), a Metropolitan Area Network (MAN), a storage area network (SAN), a frame relay connection, an Advanced Intelligent Network (AIN) connection, a synchronous optical network (SONET) connection, a digital T1, T3, E1, or E3 line, a Digital Data Service (DDS) connection, a Digital Subscriber Line (DSL) connection, an Ethernet connection, an Integrated Services Digital Network (ISDN) line, a dial-up port such as a V.90, a V.34, or a V.34bis analog modem connection, a cable modem, an Asynchronous Transfer Mode (ATM) connection, a Fiber Distributed Data Interface (FDDI) connection, a Copper Distributed Data Interface (CDDI) connection, or an optical/DWDM network.

The storage 160 may include one or more machine-readable storage media such as read-only memory (ROM), random-access memory (RAM), magnetic disk storage media, optical storage media, flash-memory devices, or similar storage media. In various embodiments, the storage 160 may store instructions for execution by the processor 120 or data upon which the processor 120 may operate.

For example, the storage 160 may include a dense feature(s) module 161 for calculating a rich set of dense features relating to each entity of interest. The dense feature(s) module 161 may include instructions to execute a model such as a neural network.

The external feature(s) module 162 may store or otherwise receive from storage data regarding external features about the entities. This data may include data regarding certain users, for example, such as their age, gender, or the like.

The target value estimation module 163 may combine the internally inferred (i.e., dense) features from the dense feature(s) module 161 with the externally provided features from the external feature(s) module 162 using a neural network framework. The output of the target value estimation module 163 may be a predicted or otherwise target value relating to a data science problem.

The analyzed data may be in a form that allows for structured queries on native data. The data may be represented as a key-value paired tuple (similar to how schema-less databases stores data). These tuples may be defined by id₁, id₂, and Op (operation).

The value(s) can be of various data types including, but not limited to, numeric (e.g., numbers), vectors (e.g., a vector of numbers), categorical (e.g., a categorical data type with the category represented as a string), text (e.g., text or string information), images (which can be a URL linking to an image or raw data), and geospatial data (which may be represented in GeoJSON form). This list of data types is merely exemplary, and other types of data may be considered in accordance with the features of the systems and methods described herein.

The tuple format described above may be seen in Table 1, below:

TABLE 1
Exemplary Tuple Dataset

| id₁ | id₂ | Op | Value |
|---|---|---|---|
| u₁ | m₁ | Rating | R₁ |
| u₂ | m₂ | Rating | R₂ |

In exemplary Table 1 above, column id₁ includes users u₁, u₂, . . . , uₙ where n is the number of users in a dataset. In this particular example, column id₂ may refer to data entries that have some association with the user, e.g., movies viewed by the user (i.e., m₁ corresponds to a first movie, m₂ corresponds to a second movie, etc). Column Op (operator) specifies the relationship between id₁ and id₂, and the Value function V column specifies the value of that operator.

For example, in Table 1, the operator Op is “rating” and the value V would be rating R₁ (e.g., a numerical value) that user u₁ has assigned to movie m₁. For example, user u₁ may have rated movie m₁ a value of 8 out of a possible 10, indicating that user u₁ enjoyed movie m₁.

Accordingly, the data framework described herein may comprise a set of interactions between different entities and values associated with those interactions. For example, in the retail context, the entities may be users (e.g., shoppers) and items on sale, and the interaction may be the number of times the user(s) browse each item. As another retail example, entities may be items and stores, and the interaction may be the number of times the item is sold by each store.

In other embodiments or contexts, the analyzed data may relate to features about each entity. For example, these features may be a type of item (e.g., shoes/dresses), as well as their color, size, material, etc.; store size and location; pictures of an item; text description, or the like.

One is often interested in predicting missing values for interactions or features. For example, one may want to predict the number of times a particular item may sell in a particular store in the upcoming month. Or, as another example, one may want to classify an item's material based on other features and interactions with other entities (e.g., users, stores, etc.).

As another example and with reference to Table 1, one may want to predict the rating a particular user may assign to a particular movie. This data may be leveraged to predict movies to users that they may enjoy, for example.

The systems and methods described herein accomplish this in two stages. The first stage involves finding a rich set of dense features for each entity. This may be referred to as an embedding stage.

The second stage involves taking these rich features and combining them with externally provided features to estimate a target or otherwise missing value. This can be done by adding a number of densely connected layers from the input (i.e., the features from the first stage) to externally provided features. These stages are jointly optimized for performance on training data.

The systems and methods described herein operate under the assumption that any function involving the id₁, id₂, and Op tuple can be represented by the tensor framework described above. For notation purposes, id₁, id₂, and Op may be represented by i, j, and k, respectively.

Any value function V based on i, j, and k can be represented as:

V=f(Xᵢ,Yⱼ,Zₖ)(Aᵢⱼ,Bⱼₖ,Cₖᵢ)

### Where:

Xᵢ represents a feature vector for id₁;

Yj represents a feature vector for id₂;

Zₖ represents a feature vector for Op;

Aᵢⱼ represents a feature vector of the combination of i and j;

Bⱼₖ represents a feature vector for the combination of j and k; and

Cₖᵢ represents a feature vector for the combination of i and k.

Most existing data science models only leverage the first three parameters Xᵢ, Yj, and Zₖ. In these cases, the value function V can be represented as an approximation V′, wherein the approximation V′ is defined by:

V′=f′(Xᵢ,Yⱼ,Zₖ)

The systems and methods described herein can eventually take not only Xᵢ, Yj, and Zₖ, as inputs to a neural network, but also Aᵢⱼ, Bⱼₖ, and Cₖᵢ. Additionally, and in contrast to other models and techniques, the neural network framework described herein can approximate any function in the whole function space. By leveraging a universal format or language, the systems and methods described herein can solve any data science problem using these techniques.

In operation, the first stage calculates a feature vector for each of id₁, id₂, and Op using a first neural network with id₁, id₂, and Op as inputs to infer internal features thereof. This neural network may be used to find a rich set of dense features and output the feature vectors xᵢ, yⱼ, and Zₖ.

For example, this stage involves calculating vectors xᵢ for user u₁, for user u₂ and so on, and vectors yⱼ for m₁, for m₂, and so on. These vectors may then be fed back as inputs into the value function V to get values for a new set of id₁, id₂, etc.

The systems and methods described herein provide a novel neural network framework to predict missing entries in the second stage. As discussed previously, the columns id₁, id₂, and Op of Table 1 may be represented by i, j, and k, respectively.

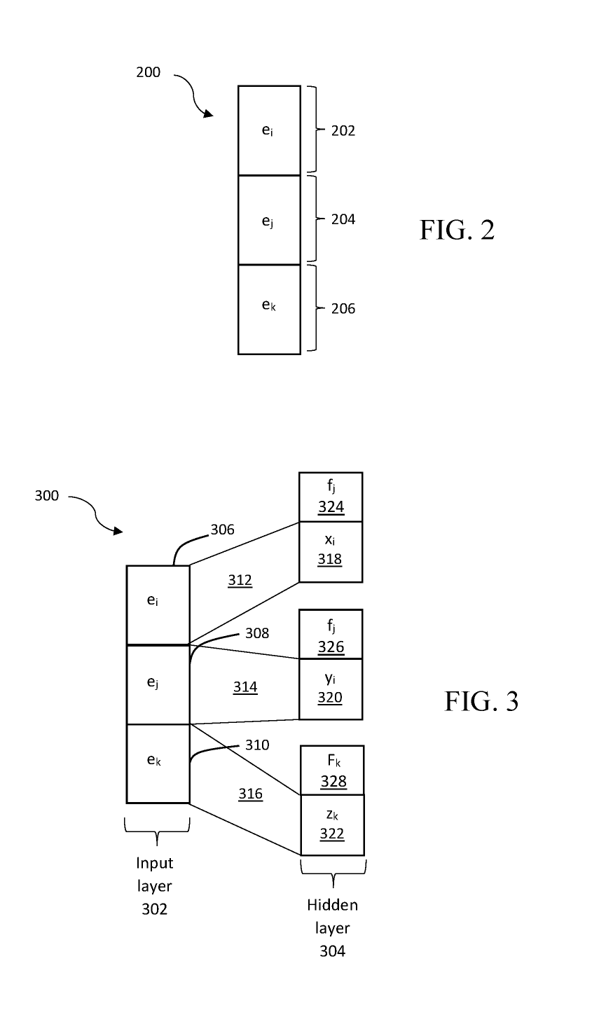

FIG. 2 illustrates a vector 200 that forms the input layer of a neural network framework in accordance with one embodiment. As seen in FIG. 2, the vector 200 includes vector eᵢ 202, vector eⱼ 204, and vector eₖ 206. Each of the vectors 202, 204, and 206 are one-hot encoded vectors. One-hot encoded are vectors that comprise several zero (“0”) values and a single one (“1”) value. For instance, a first user may be represented by vector [1, 0, 0, 0, 0], and a second user may be represented by vector [0, 1, 0, 0, 0]. These are only examples, and the one-hot encoded vectors described herein may comprise several more entries. Vector eᵢ 202 refers to id₁ of Table 1, vector eⱼ 204 refers to id₂ of Table 1, and vector eₖ refers to Op of Table 1.

FIG. 3 illustrates a neural network framework 300 in accordance with one embodiment. As seen in FIG. 3, the neural network framework 300 includes an input layer 302 that is made up of an input vector such as the vector 200 of FIG. 2. As in FIG. 2, this vector of the input layer 302 includes individual, one-hot encoded vectors eᵢ 306, eⱼ 308, and eₖ 310.

Vector eᵢ 306 corresponds to a first entity such as a first user and the hidden layer 304 encapsulates features corresponding to this first user. As with existing neural networks, the layers of the neural network framework 300 of FIG. 3 are connected and weighed by weights 312, 314, and 316.

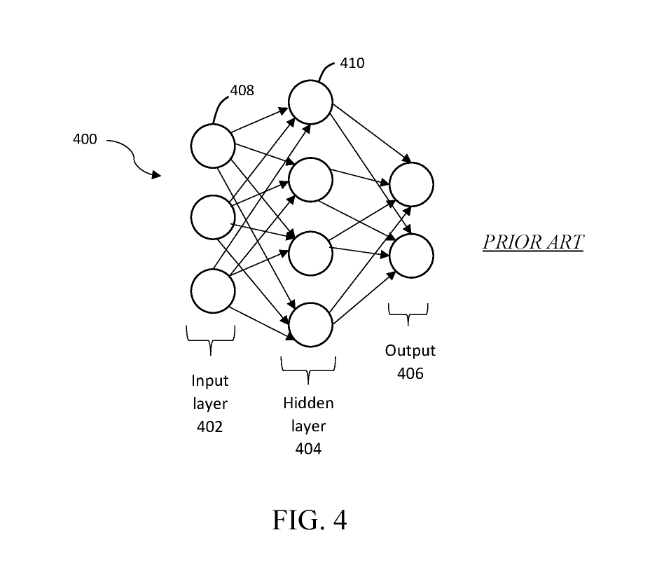

FIG. 4, for example, shows a configuration of a conventional neural network 400. The conventional neural network 400 includes an input layer 402, one or more hidden layers 404, and an output layer 406. As seen in FIG. 4, each node 408 of the input layer 402 is connected to each node 410 of the hidden layer 404. In other words, a single node in the input layer 402 is connected to all nodes 410 of the hidden layer 404, and a single node 410 in the hidden layer 404 is connected to all nodes 408 of the input layer 402.

Unlike conventional neural networks, the neural network framework 300 of FIG. 3 connects only subsets of the input layer 302 to only subsets of the hidden layer 304. That is, vector eᵢ 306 is not connected to each node of the hidden layer 304, but only one node thereof. Similarly, vector eⱼ 308 of the input layer 302 is connected to only a subset of the hidden layer 304, which is a different subset than the one connected to vector eⱼ 306 and vector eₖ 310. This reduces the amount of data needing to be analyzed by the neural network framework 300.

The portions or nodes of the hidden layer 304 to which the vectors of the input layer 302 are connected may encapsulate the internally inferred features related to each entity i, j, and k (i.e., the dense features calculated in the first stage). As seen in FIG. 3, vector eᵢ 306 is connected to node xᵢ 318, vector eⱼ 308 is connected to node)), 320, and vector eₖ 310 is connected to node zᵢ 322.

Fᵢ 324, fⱼ 326, and fₖ 328 are vectors that correspond to externally provided features (e.g., about users, about movies, etc.) and are combined with the internally inferred features. For example, in the case of considering users, movies, and the ratings the users assign to movies, the externally provided features may relate to data about the users (e.g., their age, gender, etc.) and the movies (e.g., genre, cast, etc.). These feature vectors 324, 326, 328 are fed directly to the hidden layer 304 as opposed to the input layer 302.

In the hidden layer 304, the combination of externally provided features f 324 and internally inferred feature xᵢ 318 can be referred to as Xᵢ. The combination of externally provided features f 326 and internally inferred features yⱼ 320 can be referred to as Yⱼ. The combination of externally provided features fₖ 328 and internally inferred features zₖ 322 can be referred to as Zₖ.

It is noted that k corresponds to Op, which usually does not have externally provided features. Accordingly fₓ 328 may be “empty” and only internally inferred features zᵢ 322 are considered.

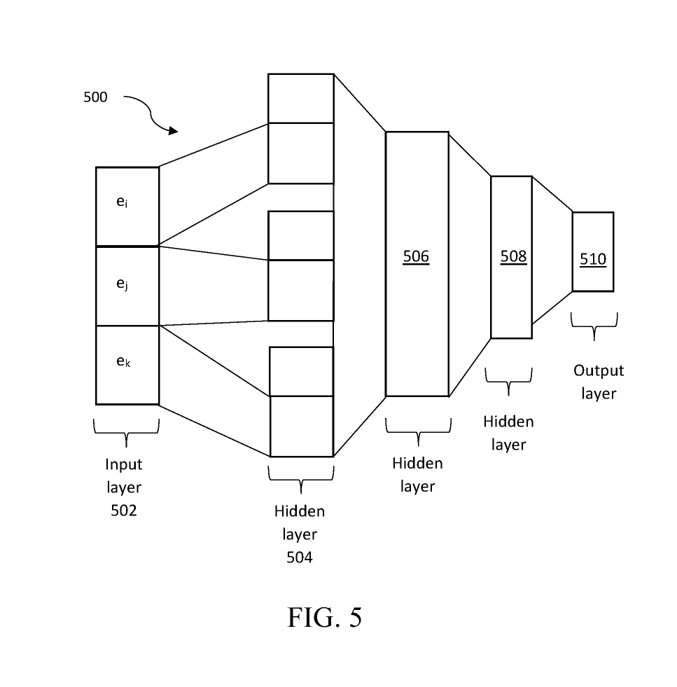

FIG. 5 illustrates a neural network framework 500 that includes an input layer 502 and a first hidden layer 504 such as the input layer 302 and hidden layer 304, respectively, of FIG. 3. After the input layer 502 and the first hidden layer 504, the neural network framework 500 has fully connected layers. These include hidden layers 506 and 508, as well as an output layer 510.

The layers 502, 504, 506, 508, and 510 are connected by weighted synapses. The number of neurons in the input layer nₗ_{₁} of the neural network frameworks shown in FIGS. 3 and 5 can be represented by:

nₗ_{₁}=nᵢ+nⱼ+nₖ

where nᵢ is the number of unique values of i.

The number of weights may be determined by:

Number of weights=(nᵢ+nⱼ+nₖ)·d_{ALS}+3(d_{ALS}+d_{FI})·d₁+d₁d₂+d₂d₀

where:
the number of neurons in the third layer 506 nₗ_{₃}=d₁;
the number of neurons in the fourth layer 508 nₗ_{_{4=d}}₂; and

nₗ_{₅}=d₀.

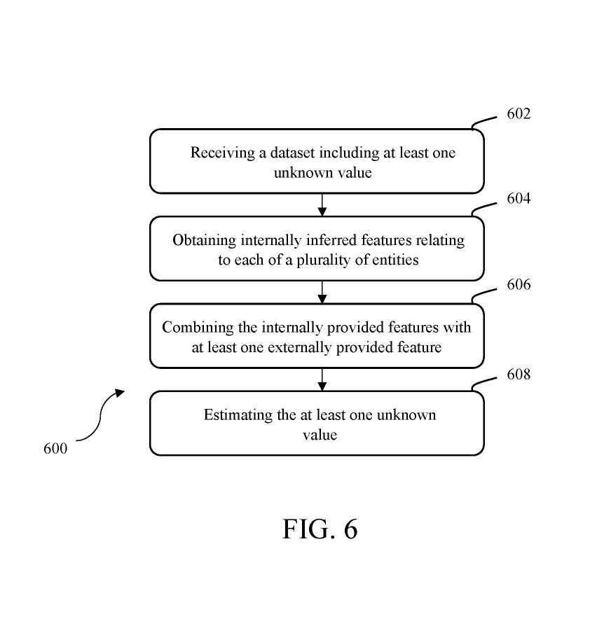

FIG. 6 depicts a flowchart of a method 600 for completing at least one entry in a dataset in accordance with one embodiment. Step 602 of the method 600 involves receiving at an interface a dataset including at least one unknown value. As discussed previously, oftentimes interested parties may want to predict an unknown value in a dataset, such as how many items a particular store will sell.

Step 604 involves obtaining, using a processor executing instructions stored on a memory to provide a model, internally inferred features relating to each of a plurality of entities. These internally inferred features may be obtained by executing a neural network.

Step 606 involves combining the internally inferred features relating to each of the plurality of entities with at least one externally provided feature related to each entity. In some embodiments, the executed model may be a neural network such as that described in FIGS. 3 and 5. In these embodiments, the input layer comprises a plurality of one-hot encoded vectors. Each portion of the input layer (e.g., a single one-hot encoded vector) is connected to only a subset of the hidden layer such that each one-hot encoded vector is connected to a different subset of the hidden layer. The subsets of the hidden layer to which the one-hot encoded vectors are connected are then combined with externally provided features relating to the entity corresponding to the connected one-hot encoded vector.

Step 608 involves estimating the at least one unknown value based on the combination of the internally provided features relating to each entity and the at least one externally provided feature related to each entity.

Embodiments of the present disclosure, for example, are described above with reference to block diagrams and/or operational illustrations of methods, systems, and computer program products according to embodiments of the present disclosure. The functions/acts noted in the blocks may occur out of the order as shown in any flowchart. For example, two blocks shown in succession may in fact be executed substantially concurrent or the blocks may sometimes be executed in the reverse order, depending upon the functionality/acts involved. Additionally, or alternatively, not all of the blocks shown in any flowchart need to be performed and/or executed. For example, if a given flowchart has five blocks containing functions/acts, it may be the case that only three of the five blocks are performed and/or executed. In this example, any of the three of the five blocks may be performed and/or executed.

A statement that a value exceeds (or is more than) a first threshold value is equivalent to a statement that the value meets or exceeds a second threshold value that is slightly greater than the first threshold value, e.g., the second threshold value being one value higher than the first threshold value in the resolution of a relevant system. A statement that a value is less than (or is within) a first threshold value is equivalent to a statement that the value is less than or equal to a second threshold value that is slightly lower than the first threshold value, e.g., the second threshold value being one value lower than the first threshold value in the resolution of the relevant system.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide those skilled in the art with an enabling description for implementing described techniques. Various changes may be made in the function and arrangement of elements without departing from the spirit or scope of the disclosure.

Having described several example configurations, various modifications, alternative constructions, and equivalents may be used without departing from the spirit of the disclosure. For example, the above elements may be components of a larger system, wherein other rules may take precedence over or otherwise modify the application of various implementations or techniques of the present disclosure. Also, a number of steps may be undertaken before, during, or after the above elements are considered.

Having been provided with the description and illustration of the present application, one skilled in the art may envision variations, modifications, and alternate embodiments falling within the general inventive concept discussed in this application that do not depart from the scope of the following claims.

What is claimed is:

1. A system for completing at least one entry in a dataset, the system comprising:
an interface for receiving a dataset, wherein the dataset includes at least one unknown value;
a processor executing instructions stored on a memory to provide a model to:
obtain internally inferred features relating to each of a plurality of entities;
combine the internally inferred features relating to each of the plurality of entities with at least one externally provided feature related to each entity; and
estimate the at least one unknown value based on the combination of the internally provided features relating to each entity and the at least one externally provided feature related to each entity.

2. The system of claim 1 wherein the model is a neural network.

3. The system of claim 2, wherein the internally inferred features are arranged as a plurality of one-hot encoded vectors that each relate to an entity.

4. The system of claim 3, wherein the plurality of one-hot encoded vectors represent an input layer of the neural network, and the at least one externally provided feature is represented as a portion of a hidden layer of the neural network.

5. The system of claim 4 wherein a first one-hot encoded vector relating to a first entity is combined with the portion of the hidden layer that represents the at least one externally provided feature that relates to the first entity.

6. The system of claim 1 wherein the processor is further configured to output a target vector estimating the at least one unknown value.

7. A method for completing at least one entry in a dataset, the method comprising:
receiving at an interface a dataset including at least one unknown value;
obtaining, using a processor executing instructions stored on a memory to provide a model, internally inferred features relating to each of a plurality of entities;
combining the internally inferred features relating to each of the plurality of entities with at least one externally provided feature related to each entity; and
estimating the at least one unknown value based on the combination of the internally provided features relating to each entity and the at least one externally provided feature related to each entity.

8. The method of claim 7 wherein the model is a neural network.

9. The method of claim 8 wherein the internally inferred features are arranged as a plurality of one-hot encoded vectors that each relate to an entity.

10. The method of claim 9 wherein the plurality of one-hot encoded vectors represent an input layer of the neural network, and the at least one externally provided feature is represented as a portion of a hidden layer of the neural network.

11. The method of claim 10 wherein combining the internally inferred features relating to each of the plurality of entities with the at least one externally provided feature includes combining a first one-hot encoded vector relating to a first entity with the portion of the hidden layer that represents the at least one externally provided feature that relates to the first entity.

12. The method of claim 7 wherein the processor is further configured to output a target vector estimating the at least one unknown value.
